(19) United States
(12) Patent Application Publication
(10) Pub. No.: US 2015/0350604 A1
(43) Pub. Date: Dec. 3, 2015

(54) METHOD AND SYSTEM FOR MULTIPARTY VIDEO CONFERENCING

(71) Applicant: Highfive Technologies, Inc., Redwood City, CA (US)

(72) Inventors: Jeremy ROY, Woodside, CA (US); Ching Yin Derek PANG, San Francisco, CA (US); Ohene Kwasi OHENE-ADU, Santa Clara, CA (US); Edward WEI, Palo Alto, CA (US); Sankara Narayana Hemanth MEENAKSHISUNDARAM, Sunnyvale, CA (US)

(21) Appl. No.: 14/726,307

(22) Filed: May 29, 2015

Related U.S. Application Data
(60) Provisional application No. 62/005,431, filed on May 30, 2014.

(51) Int. Cl. H04N 7/15

(52) U.S. Cl. CPC H04N 7/155; H04N 7/152

(57) ABSTRACT

A method and apparatus are provided that are implemented at a conference apparatus to provide an optimization of video conferencing resource utilization. The method receives a plurality of resource constraints where each resource constraint is from a conference device in a plurality of conference devices, wherein at least a first resource constraint of a first conference device contains an indication of a video processing capability of the first conference device. The method further computes a conference solution matrix for the plurality of conference devices based on the plurality of resource constraints, wherein the conference solution matrix contains a solution entry for each of the plurality of conference devices, and wherein for the first conference device, a corresponding first solution entry indicates a video processing solution selection for the first conference device. Solution entries are then sent to corresponding conference devices of the plurality of conference devices.

### CROSS-REFERENCE TO RELATED APPLICATION

This application claims priority to U.S. Provisional Patent Application No. 62/005,431, filed on May 30, 2014. This application is related to co-pending U.S. patent application Ser. No. not yet assigned, Attorney docket No. 9705P001, entitled “DOMAIN TRUSTED VIDEO NETWORK,” and co-pending U.S. patent application Ser. No. not yet assigned, Attorney docket No. 9705P002, entitled “PROXIMITY-BASED CONFERENCE SESSION TRANSFER,” both filed herewith, which are incorporated herein by reference.

### FIELD OF INVENTION

The embodiments of the invention are related to the field of conferencing. More specifically, the embodiments of the invention relate to a method and system for supporting multiparty video conferencing.

### BACKGROUND

Conferencing as a technology allows two or more locations to communicate by supporting simultaneous two-way transmission between multiple locations. When the conferencing includes video transmission between the different locations, it is generally referred to as video conferencing. Video conferencing uses audio and video transmission to facilitate communication between people at different locations and it reduces the need to travel for meetings and collaboration, thus it has become popular in both residential and commercial settings.

A multiparty video conference is a video conference that involves more than two parties. Each party uses a conference device to participate in the video conference, and the various conference devices of the parties may have different capacities to process and or transmit video. In addition, with video being transmitted among multiple locations and video conferencing consuming a significant amount of network bandwidth in the network carrying the video traffic, network bandwidth can vary widely at various locations in the network as the video traffic traverses the network. The video transmitted between each of the conference devices over a network can traverse may links and nodes that may form bottlenecks for the video transmission. The multiple streams of video sent between the conference devices however do not all traverse the same routes and bottlenecks. This causes different throughput between the conference devices. Thus, it is challenging to maintain a consistent quality for each participant of a multiparty video conference.

### SUMMARY

Embodiments of the invention aim at providing conference solutions for multiple conference devices based on the resource constraints of conference devices so that the conference devices may participate a conference session with all resource constraints satisfied.

The embodiments encompass a method implemented at a conference device. The method includes receiving a plurality of resource constraints from a plurality of conference devices, wherein at least a first resource constraint of a first conference device is received that contains an indication of video processing capability of the first conference device. The method computes a conference solution matrix for the plurality of conference devices based on the plurality of resource constraints, wherein the conference solution matrix contains a solution entry for each of the plurality of conference devices, and wherein for the first conference device, a corresponding first solution entry indicates a video solution selection for the first conference device. The method sends the solution entries to corresponding conference devices of the plurality of conference devices, wherein the corresponding conference devices configure their settings for conferencing based on the solution entries.

The embodiments include an apparatus including a memory configured to store data and instructions and a processor configured to execute a network interface and a conference solution generator stored in the memory. The network interface is configured to receive a plurality of resource constraints from the plurality of conference devices, a resource constraint for each conference device, wherein at least a first resource constraint of a first conference device contains an indication of the video processing capability of the first conference device, and the network interface is further configured to send solution entries of a conference solution matrix to corresponding conference devices of the plurality of conference devices, wherein the corresponding conference devices configure their settings for conferencing based on the solution entries. The conference solution generator is configured to compute the conference solution matrix for the plurality of conference devices based on the plurality of resource constraints, wherein the conference solution matrix contains a solution entry for each of the plurality of conference devices, and wherein for the first conference device, a corresponding first solution entry indicates a video solution selection for the first conference device.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this specification are not necessarily to the same embodiment, and such references mean at least one. Further, when a particular feature, structure, or characteristic is described in connection with an embodiment, it is submitted that it is within the knowledge of one skilled in the art to affect such feature, structure, or characteristic in connection with other embodiments whether or not explicitly described.

FIG. 1 illustrates a system for multiparty video conferencing.

FIG. 2 illustrates a multiparty video conference system utilizing a conference server according to one embodiment of the invention.

FIG. 3 illustrates a scalable video coding process used in video conferencing according to one embodiment of the invention.

FIG. 4 illustrates a multiparty video conference session adjusting a conference solution according to one embodiment of the invention.

FIG. 5 illustrates a video conference system without a conference server according to one embodiment of the invention.

FIG. 6 is a flow diagram illustrating flow control of a multiparty video conference session according to one embodiment of the invention.

FIG. 7 is a flow diagram illustrating flow control adjustment of a multiparty video conference session according to one embodiment of the invention.

FIG. 8 is a block diagram illustrating a conference apparatus that may be used with one embodiment of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description. It will be appreciated, however, by one skilled in the art that the invention may be practiced without such specific details. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other. A “set,” as used herein refers to any positive whole number of items including one item.

An electronic device stores and transmits (internally and/or with other electronic devices over a network) code (which is composed of software instructions and which is sometimes referred to as computer program code or a computer program) and/or data using machine-readable media (also called computer-readable media), such as non-transitory machine-readable media (e.g., machine-readable storage media such as magnetic disks, optical disks, read only memory, flash memory devices, phase change memory) and transitory machine-readable transmission media (also called a carrier) (e.g., electrical, optical, radio, acoustical or other form of propagated signals—such as carrier waves, infrared signals). Thus, an electronic device (e.g., a computer) includes hardware and software, such as a set of one or more processors coupled to one or more non-transitory machine-readable storage media (to store code for execution on the set of processors and data) and a set of one or more physical network interface(s) to establish network connections (to transmit code and/or data using propagating signals). Put another way, a typical electronic device includes memory comprising non-volatile memory (containing code regardless of whether the electronic device is on or off) and volatile memory (e.g., dynamic random access memory (DRAM), static random access memory (SRAM)), and while the electronic device is turned on that part of the code that is currently being executed is copied from the slower non-volatile memory into the volatile memory (often organized in a hierarchy) for execution by the processors of the electronic device.

Flow Control of Multiparty Video Conferencing

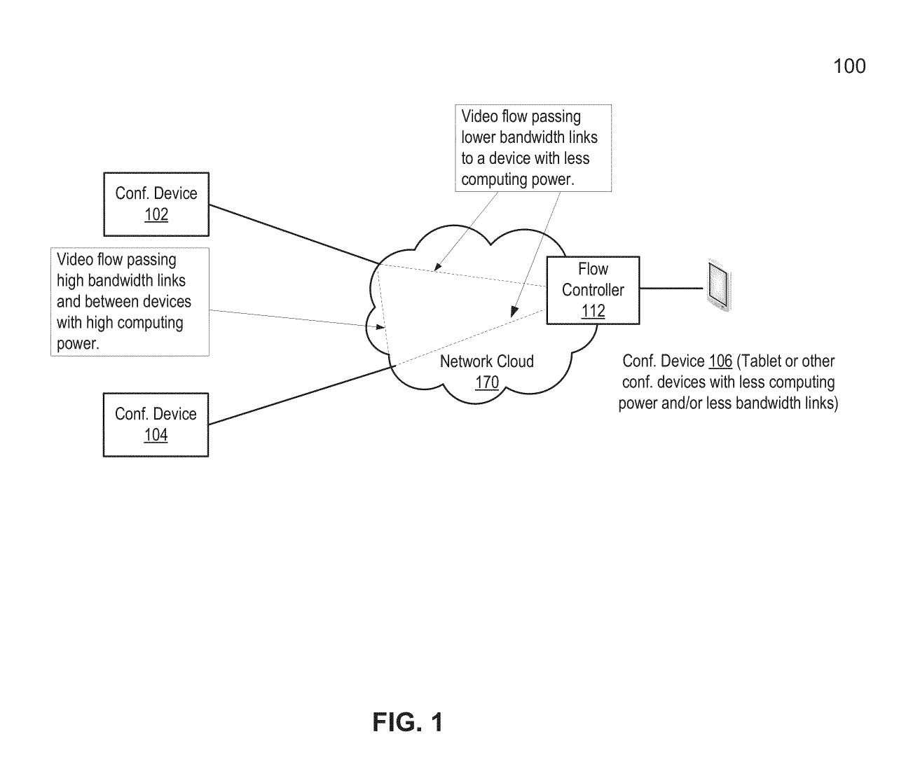

FIG. 1 illustrates a system for multiparty video conferencing. The conference system 100 contains conference devices 102, 104, and 106. The conference devices are coupled to network cloud 170. A multiparty video conference session is set up among the three conference devices.

Conference devices are electronic devices capable of performing conferencing related tasks (e.g., encoding/decoding audio/video streams), and they may be workstations, laptops, netbooks, tablets, palm tops, mobile phones, smartphones, multimedia phones, Voice Over Internet Protocol (VOIP) phones, terminals, portable media players, GPS units, wearable devices, gaming systems, set-top boxes, and Internet enabled household appliances. Some conference devices (e.g., a conference station in a conference room) are dedicated to conferencing, and generally contain a processor with high computing power. Others contains processors with less computing power. For example, conference devices 102 and 104 have high computing power while conference device 106 represents a device with less computing power such as a tablet (or a smartphone, a wearable device, etc.).

Network cloud 170 may be any type of network such as a local area network (LAN), a wide area network (WAN), such as the Internet, a corporate intranet, a metropolitan area network (MAN), a storage area network (SAN), a bus, or any combination thereof, with constituent links of these networks being wired and/or wireless. Links of network cloud 170 have different bandwidths and cause different delays/jitters in video transmission. For example, the links between conference device 102 and 104 may have a higher bandwidth while the links to conference device 106 may have a lower bandwidth.

In a video conference session, some or all conference devices transmit video streams to other conference devices. The conference devices capture video frames at a location, for example, a video stream displays the participant in a video conference room or at a desk. The captured frames from the video stream can sometimes be referred to as video headshots or screen shots and/or presentation of the conference device. The video stream is then encoded and transmitted to other conference devices, where the video stream is then decoded and displayed via a display device such as a monitor attached to the other conference devices. Note that a video stream is commonly accompanied by one or more audio streams, and they are considered as parts of a video conference session unless noted otherwise. Note that conference devices have the capability to tolerate video packet delays, jitters, and loss during transmission of the video stream, based on the video quality of the video stream as it is received at the conference devices.

In order to maintain a consistent quality for a multiparty video conference among conference devices 102, 104, and 106, a straightforward approach is to find a lowest common denominator of all parties participating in the multiparty video conference. For example, one solution may be to encode/decode video/audio streams at a level within the capacity of conference device 106, which has the least computing power and/or lowest bandwidth connection. This solution also needs to capture video at a rate such that the generated video stream can be transmitted at a bandwidth that does not overwhelm the lowest bandwidth links between the conference devices. While this solution guarantees that a video conference session can be initiated and maintained by all conference devices, the quality of video is less than, for example, what conference devices 102 and 104 could support. In other words, any time there is a conference device (1) with a lower computing power and/or (2) coupled to lower bandwidth links that is participating in a video conference session, the video conference session will use lower quality video streams (e.g., lower resolution video captured at slower frame rate).

Another approach that improves the video quality of a video conference session is to add a flow controller at the edge of network facing the conference device with less computing power, lower video encoding/decoding capability, and/or less bandwidth links. Flow controller 112 is such a device for conference device 106. Flow controller 112 resides at the edge of network cloud 170, and it converts received high quality video streams from conference devices 102/104 to lower quality video streams such that conference device 106 is able to process them with its lower computing power, lower video encoding/decoding capability, and/or lower bandwidth links. In this approach, the video quality between conference devices with high computing power and higher video encoding/decoding capability, coupled to high bandwidth links is not impaired because of the participation of a conference device with lower computing power and/or coupled to lower bandwidth links. Note that the flow controller may be used for managing other deficiencies of some network devices too, such as uplink bandwidth, downlink bandwidth, encoding complexity budget, decoding complexity budget, maximum allowable simulcast streams per endpoint, and capability constraints such as display estate and user interface.

However, a disadvantage of this approach is that the flow controlling is a computing intensive process requiring an electronic device with substantial computing power to maintain a video conference session. Also, the operator of the network cloud and the operator of video conferencing are often different entities, and it is not easy to place a flow controller for video conferencing at the edge of the network cloud. Thus, a video flow control mechanism not depending on a flow controller at the network is more desirable.

### Embodiments of Multiparty Video Conferencing a Utilizing Conference Server

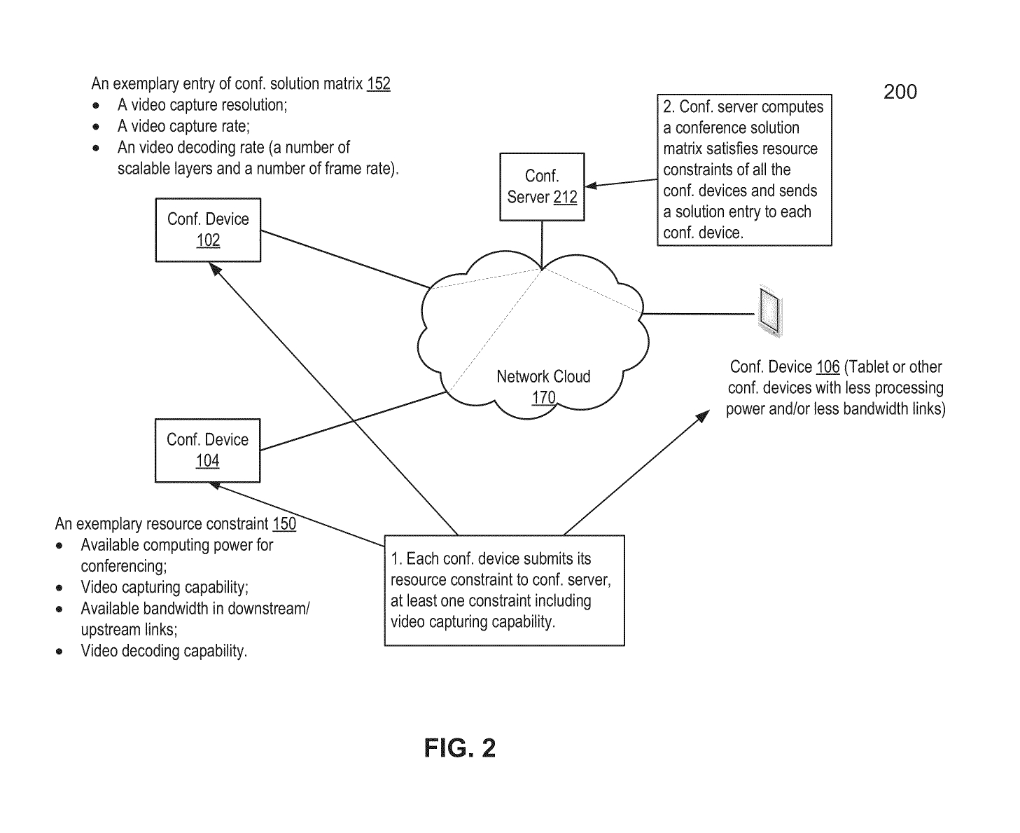

FIG. 2 illustrates a multiparty video conference system utilizing a conference server according to one embodiment of the invention. The video conference system initiates and maintains one or more video conference sessions among conference devices 102, 104, and 106. The process of flow control is illustrated with task boxes, and task boxes 1 and 2 illustrate the order in which operations are performed according to one embodiment of the invention.

At task box 1, each conference device submits its resource constraint to a conference server, where at least one of the resource constraints includes the conference device's video capturing capability. Each resource constraint may contain multiple values, and these values may form a resource constraint using array, tuple, table, or other data structures. Each of the conference devices may submit its resource constraints in response to inquiries from the conference server 212, in one embodiment. In an alternative embodiment, each conference device may submit its resource constraint based on a local event (e.g., a user of the conference device starts a video conference session).

An exemplary resource constraint is given at reference 150. The exemplary resource constraint includes following values:
Available computing power for conferencing. A conference device may have a high power processor but it needs to run other processes, thus the computing power for conferencing is limited. This value may include a percentage of the computing power available for conferencing, the computing power of processor(s) of the conference device and similar computing capability characteristics.
Video capturing capability. When a conference device contains a video capture apparatus (e.g., a camera), it sends out its video capturing capability such as a frame generating rate, a resolution of each video frame, and similar video capture characteristics.
Available bandwidth in downstream and upstream links. The downstream links are the links sending traffic to a conference device while the upstream links are the links receiving traffic from the conference device. They may be different links. The available bandwidth determined by a conference device may be based on multiple factors, such as observed packet loss, packet delay, and packet jitter (packet inter-arrival time) at both the downstream and upstream links. For upstream links, the information may be received from another conference device at the other end of the upstream links.
Video encoding/decoding capability. The video encoding and decoding capability includes a frame encoding and/or decoding rate and frame encoding or decoding resolution supported by the conference device. In some cases, the video encoding and/or decoding capability is also affected by available computing power for conferencing, and it may be derived based on the available computing power.

Any number or combination of resource constraint values can be reported by the conference devices. Other types of resource constrain values can include uplink bandwidth, downlink bandwidth, encoding complexity budget (i.e. resources dedicated to encoding), decoding complexity budget (i.e. resources dedicated to decoding), maximum allowable simulcast streams (i.e. reporting of user device or network constrains on number of streams), and similar constraints including client based restraints like display estate and user interface related constrains. Note that not all of the conference devices have or report the same set of values for their respective resource constraints. Some conference devices do not capture video thus they do not provide video capturing capability, and others may provide values for constraints in addition to the ones listed in the exemplary resource constraint.

The resource constraints from all the conference devices are sent to conference server 212. Conference server 212 is an electronic device capable of coordinating video conference sessions. Conference server 212 may coordinate a large number of concurrent video conference sessions.

At task box 2, conference server 212 computes a conference solution matrix for the conference devices, where the conference solution matrix satisfies resource constraints of all the conference devices, and it sends a solution entry of the conference solution matrix to each conference device. The conference solution matrix contains multiple solution entries, each solution entry corresponds to a conference device. The solution entry that corresponds to a conference device is sent to the conference device. Upon receiving the solution entry, the conference device configures its setting for conferencing based on the solution entry. For example, for a conference device capturing video, it configures its video capture resolution and rate as specified in the solution entry. Similarly, the conference device will decode the video stream received from other conference devices using the video decoding rate specified in the solution entry.

An exemplary entry of conference solution matrix is given at reference 152. The exemplary entry includes the following values:
Video capture resolution. The video capture resolution is a resolution captured for display at a monitor for a conference session. The video capture resolution generally includes the horizontal scan lines utilized to capture video at the conference device. It may be standard resolution (e.g., 480 or 576 lines interlacing), high-definition resolution (e.g., 720 or 1080 lines progressive/interlacing scanning), ultra-high-definition resolution (e.g., 2160 or 4320 lines progressive scanning), and other lower or higher resolutions.
Video capture rate. The video capture rate is a rate at which a video is captured at a conference device. A video may be captured at many different frame rates, such as 24, 30, and 60 frames per second (a higher or lower frame rate may be used at the conference devices depending on implementation).
Video decoding rate. The video decoding rate is a rate at which a conference device decodes videos. It may include a frame decoding rate such as one of 24, 30, and 60 frames per second (a higher or lower frame rate may be used at the conference devices depending on implementation). When the frames are encoded in scalable video coding, the video decoding rate may also include how many scalable layers are decoded and at which decoding rate at each layer.

Note that when the frames are encoded in scalable video coding, the entry of the conference solution matrix may include how many scalable layers need to be captured and at which encoding rate each layer is to be handled. The scalable video encoding is described in more details below. In further embodiments, the conference solution matrix can include other values for configuring the operation of each of the conference devices to optimize the operation of each of their respective audio and video processing and transmission processes.

In one embodiment, the conference solution matrix entry requests a conference device to encode multiple video streams for a single video conference session. The multiple video streams have different video capture resolutions and video capture rates. The conference device will encode as requested upon receiving the conference solution entry, and the encoded multiple video streams are then sent to conference server 212. Conference server 212 then sends a video stream with a higher video capture resolution and/or a higher video capture rate to a conference device that can decode a video stream at a higher rate. It also sends another video stream of the same conference session with a lower video capture resolution and/or a lower video capture rate to a conference device that can only decode a video stream at a lower rate. In this way, all conference devices may experience the best video quality that it can support.

Note that in one embodiment, the whole conference solution matrix may be sent to all of the conference devices participating in a video conference session. Also note that not all of the entries of the conference solution matrix have the same number of values for the conference solution. Some conference devices do not capture video, thus their entries in the conference solution matrix may not contain values relating to video capturing.

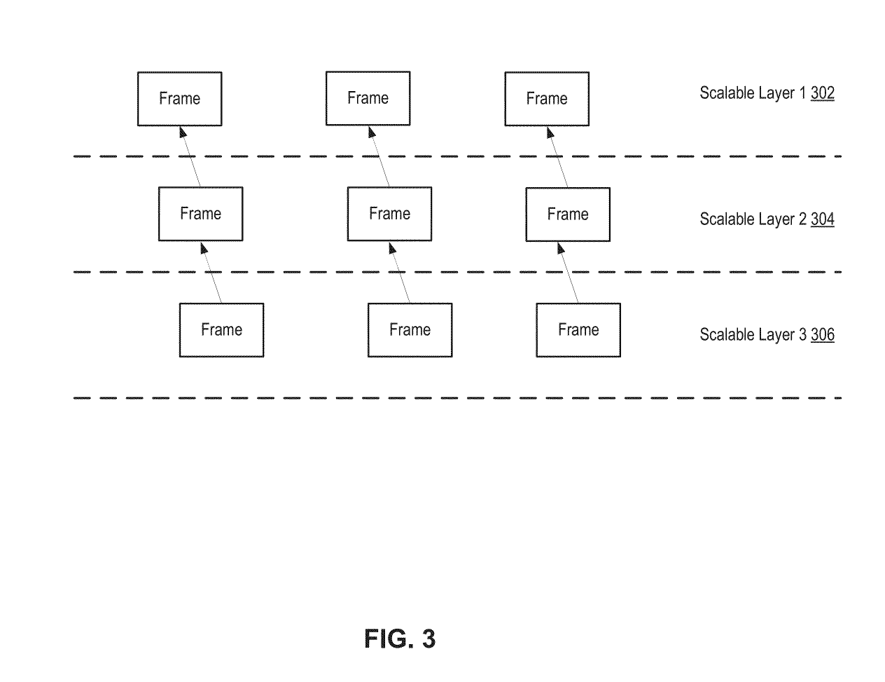

As discussed herein above, video coding in a video conference session may be encoded and decoded using scalable video coding. FIG. 3 illustrates a scalable video coding used in video conferencing according to one embodiment of the invention. As illustrated, the scalable video coding contains multiple scalable layers such as scalable layers 1, 2, and 3 at references 302, 304, and 306 respectively. The video frames at each layer can be considered as a subset of streams of a video stream so that one video stream may be encoded/decoded as multiple subsets of streams. Each frame at a lower scalable layer is derived from a frame at a higher scalable layer, and the frame at the lower scalable layer stores data variance from the frame at the higher scalable layer.

At the conference device where video frames are captured, the conference device may determine how many layers of video are to be utilized and at what frame rate to capture them, depending on the entry of the conference solution matrix it receives from the conference server (e.g., video capture resolution and rate provided). At the conference device where the video frames are decoded, the conference device similarly determines how many layers of video and at what frame rate to decode the layers, depending on the entry of the conference solution matrix it receives from the conference server (e.g., a video decoding rate can be provided as part of the entry).**

Note that the process illustrated at FIG. 2 can be performed prior to the initiation of a multiparty video conference session or during a multiparty video conference session, as the computed conference solution matrix may be used by a conference device at the start of a video conference so that the proper video stream is encoded/decoded at the beginning, or it may be used to adjust an existing video stream to make the video stream satisfy resource constraints of all of the conference devices involved in the multiparty video conference session.

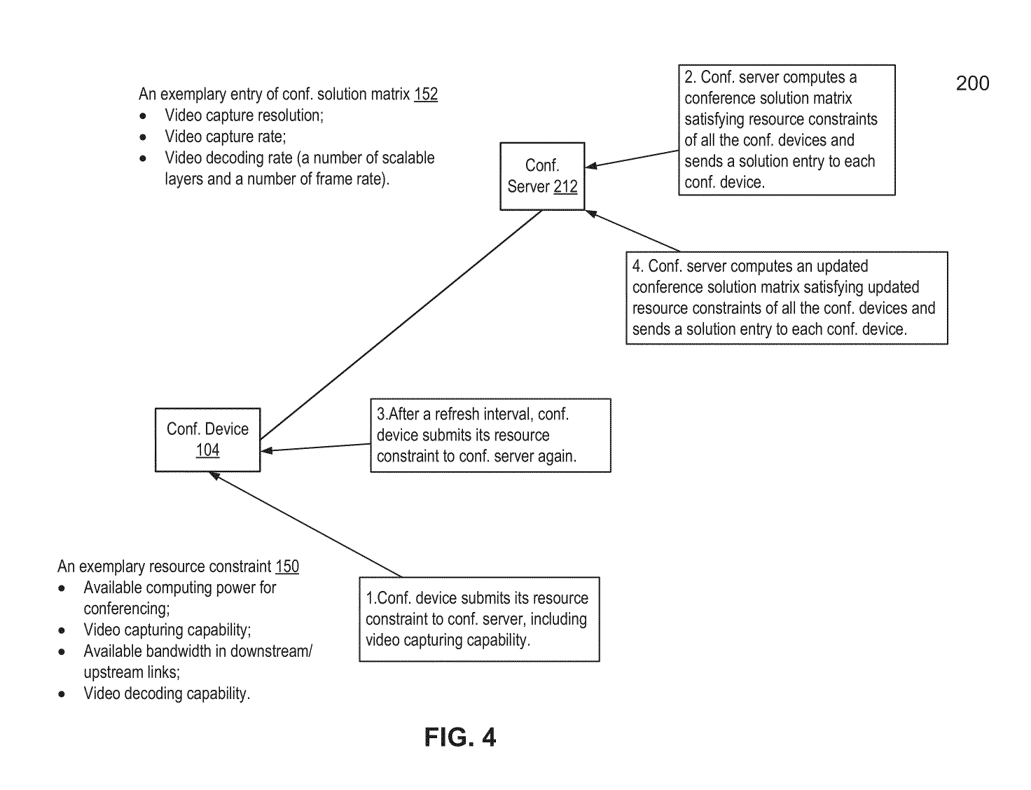

FIG. 4 illustrates a multiparty video conference session adjusting a conference solution according to one embodiment of the invention. System 200 of FIG. 4 is identical to system 200 illustrated in FIG. 2 with elements other than conference server 212 and conference device 104 being omitted for clarity of discussion. Task boxes 1 to 4 illustrate the order in which operations are performed according to one embodiment of the invention.

Referring to FIG. 4, at task boxes 1 and 2, conference device 104 and conference server 212 perform similar operations as illustrated in task boxes 1 and 2 of FIG. 2. That is, conference device 104 submits its resource constraints including its video capturing capability to conference server 212, and conference server 212 computes a conference solution matrix satisfying resource constraints it received from all of the conference devices participating in the multiparty video conference session, and sends a solution entry of the conference solution matrix corresponding to conference device 104 to conference device 104. Conference device 104 then configures its settings for conferencing based on the solution entry.

At task box 3, conference device 104 checks a timer that specifies a refresh interval, and after the timer expires, the conference device submits its resource constraint to conference server 212 again. Note the resource constraint is likely different from the resource constraint sent at task box 1 because values of the resource constraint changes with time. For example, the available computing power for conferencing changes widely from time to time based on what application the conference device is running Similarly, the available bandwidth in downstream/upstream links changes too depending on traffic load on network cloud 170. Thus, the update of the resource constraint provides an at-the-moment constraint to conference server 212.

At task box 4, conference server 212 computes an updated conference solution matrix satisfying updated resource constraints of all the conference devices involved in a conference session and sends a solution entry of the updated conference solution matrix to each conference device involved in the conference session. In computing the updated solution entry for a conference device, one consideration is a smooth transition from the existing solution entry. The updated solution entry is computed such that no visible video quality deterioration can be observed for users of the involved conference session.

Conference server 212 computes the updated conference solution matrix at a refresh interval, and the refresh interval of the conference server 212 may be the same or different from the refresh interval of conference device 104. Both refresh intervals may be programmable and the values are set based on factors such as computing power of the conference server and conference devices (the more powerful the conference server, the smaller the refresh interval it can handle). In one embodiment, the refresh intervals are set in milliseconds or seconds (e.g., 200 milliseconds or lower for both refresh intervals).

### Embodiment of Multiparty Video Conferencing Without A Conference Server

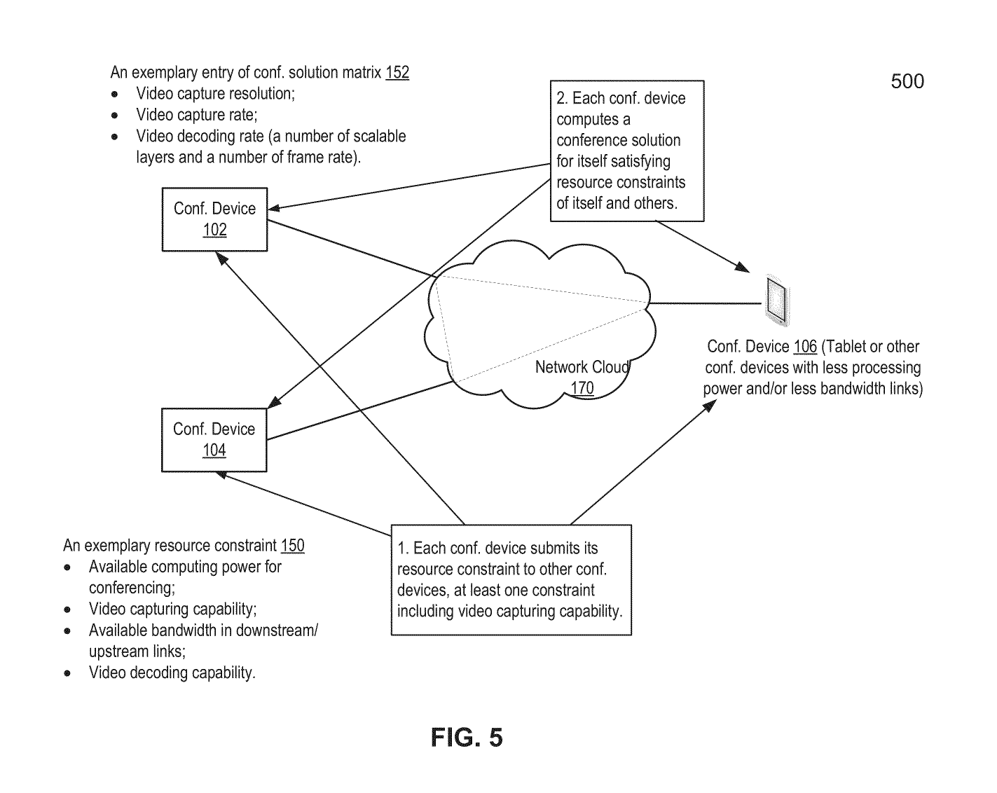

While FIGS. 2 and 4 illustrate multiparty video conferencing utilizing a conference server, the conference server is not mandatory to implement embodiments of the invention. FIG. 5 illustrates a video conference system without a conference server according to one embodiment of the invention. System 500 in FIG. 5 is similar to system 200 in FIG. 2 except that the former system does not contain a conference server. All computations are done at the conference devices involved in a multiparty video conference session. The process of flow control is illustrated with task boxes, and task boxes 1 to 2 illustrate the order in which operations are performed according to one embodiment of the invention.

At task box 1, each conference device submits its resource constraints to other conference devices that are involved in a conference session, and at least one resource constraint including the conference device's video capturing capability. Note that in an alternative embodiment, each conference device broadcasts its resource constraints to all other conference devices within system 500, regardless if there is a conference session between the conference device and another conference device.

At task box 2, each conference device computes a conference solution for itself satisfying resource constraints of itself and other conference devices. Each conference device no longer needs to compute a conference solution matrix containing conference solution entries for each conference device as conference server does in system 200. Instead, it just computes the conference solution for itself, and then it configures its settings for conferencing based on its own conference solution, similar to the conference devices in system 200.

Similar to system 200 of FIGS. 2 and 4, a multiparty video conference session of system 500 can be adjusted dynamically. That is, each conference device may update the resource constraint it sends out periodically at a refresh interval, and each conference device may compute an updated conference solution for itself satisfying the updated resource constraints of itself and others periodically at a same or different refresh interval.

Without a dedicated conference server as a central control point, the process is a distributed approach with each conference device performing its own computation. This distributed process is more flexible, but at the same time requires more computing resources at each conference device.

Flow Diagrams of Flow Control of Multiparty Video Conference Session

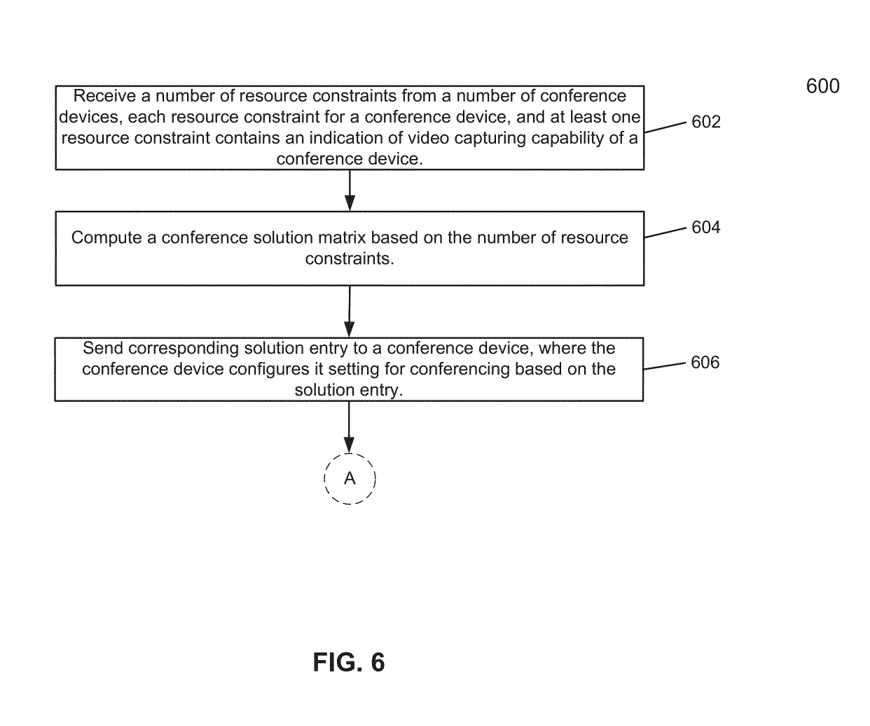

FIG. 6 is a flow diagram illustrating flow control of a multiparty video conference session according to one embodiment of the invention. Method 600 may be implemented in conference systems 200 and 500 containing more than two conference devices as illustrated in FIGS. 2 and 5. Specifically, the method may be implemented in a conference server or at a conference device, and they are collectively referred to as conference apparatus.

At reference 602, the conference apparatus receives a number of resource constraints from a number of conference devices, where each resource constraint is for a conference device, and at least one resource constraint contains an indication of video capturing capability of a conference device. The indication of video capturing capability may include a frame generating rate of the conference device, and a resolution for each video frame in one embodiment. A resource constraint may include available computing power for conferencing, available bandwidth in downstream and upstream links, video decoding capability, and other parameters as discussed herein.

At reference 604, the conference apparatus computes a conference solution matrix based on the number of resource constraints. When the conference apparatus is a conference server, the conference solution matrix contains the same number of solution entries as the number of conference devices, and each solution entry corresponds to a conference device. One of the solution entries is for the resource constraint containing the indication of video capturing capability of the conference device. When the conference apparatus is one of the number of conference devices, the conference solution matrix contains only a single solution entry, and the single solution entry is for the conference device itself.

An exemplary solution entry includes a video capture resolution for each of one or more streams sending from the conference device, a video capture rate of each of the one or more streams sending from the conference device, and a video decoding rate of each of one or more streams sending video to the conference device from one of the other conference devices. When the conference devices support scalable video coding, the solution entry may indicate the number of scalable layers to encode and decode, and the video capture/decoding rate of each of the number of scalable layers.

Note that the solution entry may include video capture resolution, video capture rate, and video decoding rate for multiple streams, instead of a single stream. That is, a conference device may encode and transmit multiple streams to other conference devices, and it may also receive and decode/display multiple streams from the other conference devices for a single conference session. In one embodiment, all the video streams are transmitted to the conference server first and the conference server delivers all received video streams to the appropriate destination conference device.

At reference 606, the conference apparatus sends a corresponding solution entry to a conference device, and the conference device configures its settings for conferencing based on the solution entry. When the conference apparatus is a conference server, it sends each of the conference devices the solution entry corresponding to the conference device. When the conference apparatus is a conference device, it just sends the solution entry to itself.

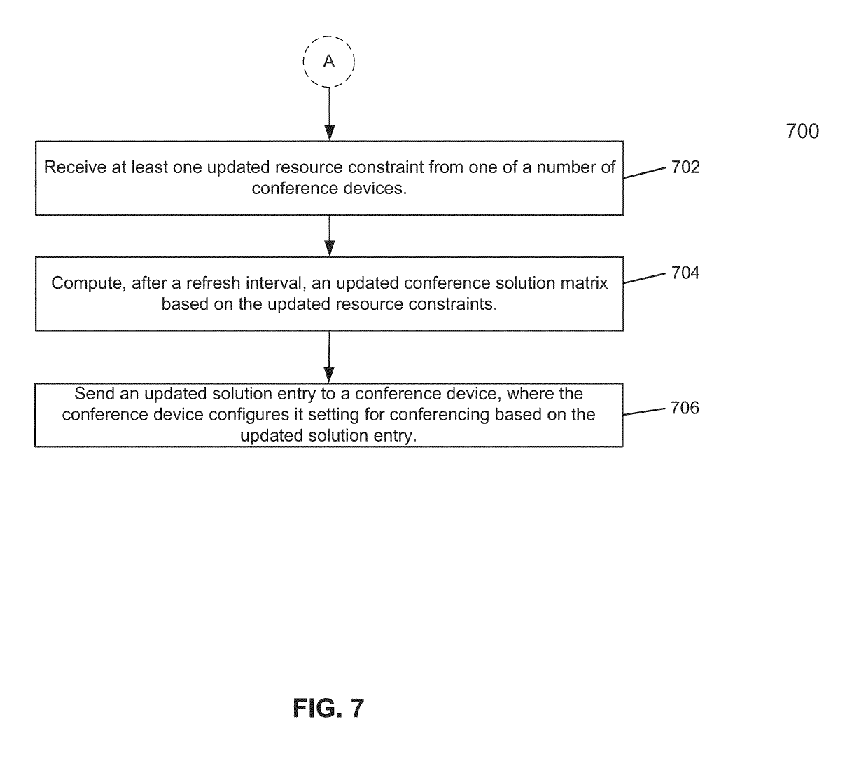

Method 600 may be performed prior to the initiation of a multiparty video conference session or during a multiparty video conference session, as the computed conference solution matrix may be used by a conference device at the start of a video conference so that the proper video stream is encoded/decoded at the beginning, or it may be used to adjust an existing video stream to make the video stream satisfy resource constraints of all of the conference devices involved in the multiparty video conference session. FIG. 7 is a flow diagram illustrating flow control adjustment of a multiparty video conference session according to one embodiment of the invention. Method 700 is performed when a multiparty video conference session is ongoing, and it may be a continuation of method 600, which is illustrated as a dotted cycle A. Method 700 may be implemented in conference systems 200 and 500 containing more than two conference devices as illustrated in FIGS. 2 and 5. Specifically, the method may be implemented in a conference server or at a conference device, and they are collectively referred to as conference apparatus.

At reference 702, a conference apparatus receives at least one updated resource constraint from one of a number of conference devices. The resource constraint may contain the same or similar values of the resource constraints of method 600 in FIG. 6. Note a conference device may have an additional or reduced number of values for its resource constraints. For example, a conference device may no longer be able to support video capturing even though it has captured video before (e.g., the video camera of the conference device is switched to a task other than the conference session). Thus, in the updated resource constraint, it no longer includes video capturing capability. On the other hand, the conference device may add video capturing capability if it becomes available. The updated resource constraints allow the video session to adjust its solution based on updated constraint information.

At reference 704, the conference apparatus computes, after a refresh interval, an updated conference solution matrix based on the updated resource constraints. When the conference apparatus is a conference server, the updated conference solution matrix contains the same number of solution entries as the number of resource constraints. When the conference apparatus is one of the number of conference devices, the conference solution matrix contains only a single solution entry, and the single solution entry is for the conference device itself.

The refresh interval is programmable and the value is set based on factors such as the computing power of the conference apparatus. In one embodiment, the refresh interval is set in milliseconds or seconds (e.g., 200 milliseconds or lower for both refresh intervals).

At reference 706, the conference apparatus sends corresponding solution entry to a conference device, and the conference device configures its settings for conferencing based on the solution entry. When the conference apparatus is a conference server, it sends each of the conference devices the solution entry corresponding to the conference device. When the conference apparatus is a conference device, it just sends the solution entry to itself.

Calculating the Conference Solution Matrix

As set forth above, the conference solution matrix is a data structure in the form of a table or similar data structure with a set of solution entries for each of the conference devices or conference apparatus that are part of a conference. A separate conference solution matrix can be calculated for each conference and may be recalculated as participants are added or dropped from the conference or as they report new conditions or resource constraints.

The goal of computing the conference solution matrix is to optimize resource allocation for the simulcast or generation of scalable video and audio streams between the conference apparatus. In other words, the process computes a set of simulcast streams or scalable layers for each conference apparatus that maximizes the perceived quality from each conference apparatus and from the perspective of the users of these conference apparatus. The inputs into this computation can include resource constraints such as uplink bandwidth, downlink bandwidth, encoding complexity budget, decoding complexity budget, maximum allowable simulcast streams per conference apparatus, and similar resource constraints including display estate (i.e. area of display device available for display of the video received) and user interface limitations such as size, resolution, refresh rate and similar characteristics.

For each conference apparatus a set of parameters can be calculated that can be referred to as simulcast or scalable parameters and stored in a solution entry for a conference apparatus. These parameters can include a number of simulcast or scalable streams, encoding bit-rate, spatial resolution, temporal resolution, H.264 encoding profile (baseline, main, high), X264 specific presets (motion estimation methods, entropy coding types, macroblock modes and similar presets) and similar configuration parameters.

In some embodiments, the process can construct a profile table or similar data structure as an intermediate or tracking data structure to track the reported resource constraints of each of the conference apparatus. In other embodiments, this information and the resulting solutions are tracked in a shared conference solution matrix or similar data structure. The profiles and/or entries in a conference solution matrix that include the resource constraints of the conference apparatus can be grouped using any subset of the resource constraints such as bit-rate, frame rate, spatial resolution and other encoding parameters. Each of the profiles or entries can be mapped to measured video qualities and relative computation budget. This grouping can identify similarly capable conference apparatus and to reduce the complexity of parameter selection and conference solution matrix calculation.

There are several alternative processes for determining resource allocation for simulcast or scalable layers to create a complete conference solution matrix for each of the conference apparatus. In one embodiment, an exhaustive approach can be employed, which is similar to a multi-dimensional knapsack problem. In the worst case this approach is of the complexity O(n^{mp}), where p is the maximum number of simulcast streams, m is the number of clients, and n is the number of profiles. The complexity is similar for generation of scalable layers in video streams. The exhaustive process: (1) finds all feasible profile sets that meet bandwidth uplink and encoding constraints for each participating sending conference apparatus, (2) uses the feasible profile sets found by the sender endpoint, finds all feasible profile sets that satisfy downlink bandwidth and receiver's constraints for each receiver conference apparatus, (3) finds the common set of profiles supported by all receiver conference apparatus, and (4) finds the optimal set which outputs the highest video quality perceived by each participating conference apparatus.

Other approaches to calculating the conference solution matrix include linear programming (LP) approximation, and a greedy approach, these approaches trade of computation and resource requirements for less optimal resource allocation results. With the LP approximation approach the process (1) finds all feasible profile sets that meet uplink bandwidth and encoding constraints for each sending conference apparatus, (2) uses the feasible profiles sets found by the sender conference apparatus and finds all feasible profile sets that satisfy the downlink bandwidth and receiver conference apparatus constraints for each receiver conference apparatus, (3) finds the common set of profiles supported by all the receiver conference apparatus, and (4) finds the optimal set which outputs the highest vide quality perceived by each conference apparatus. The process uses linear programming formulation to maximize total perceived video quality at each receiver endpoint. The process uses linear constraints for receiver conference apparatus bandwidth and other receiver side and approximation constraints. The process generates a weighted score for the possible simulcast streams or scalable layers for each sender conference apparatus that can be used to select the best simulcast stream or scalable layer to use for each conference apparatus.

With the LP based approximation the process (1) finds all feasible profile sets that meet uplink bandwidth and encoding constraints for each sending conference apparatus, (2) collects all downlink bandwidth constraints and all other constraints information from receiving conference apparatus, and (3) solves the approximated LP problem to obtain a weighted score for each simulcast stream at the receiver side. Sender side selection (4) entails the selection of the profile with the highest weighted score for each sender conference apparatus. Receiver side section (5) entails the selection of the best set of simulcast streams or scalable layers that maximize the total video quality given the constraints of the receiving conference apparatus.

An alternative embodiment utilizes a greedy approach to resource allocation for simulcast or scalable layers. The process (1) specifies the number of simulcast streams or scalable layers. The process (2) assigns the target bitrate of the first simulcast stream or scalable layer to lowest downlink bit rate or bandwidth. The process (3) assigns target bit rates of the remaining simulcast or scalable layers by clustering the downlink bit rates. On the sender side selection, the process (4) starts from the lowest bit rate target, selects the best profile that fits the sender's bit rate and/or complexity budget, then repeats this until all target bit rate streams or scalable layers are matched until bandwidth and/or complexity budgets are exhausted. For receiver side selection, the process (5) selects the best set of streams or scalable layers that maximize the total receiver vide quality given the receiver's constraints.

Electronic Devices Implementing Flow Control

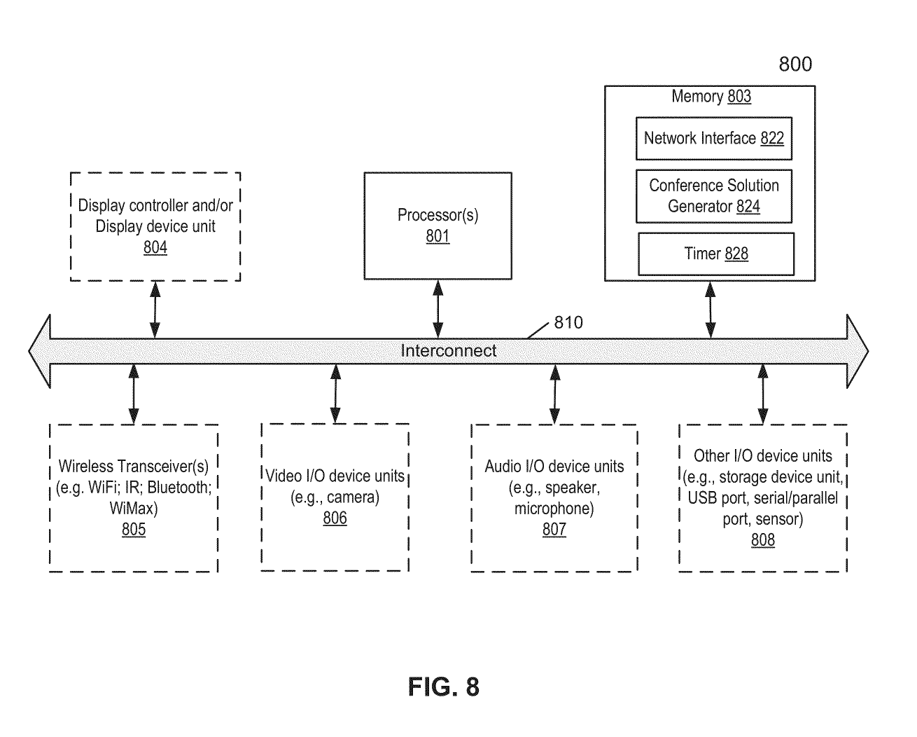

FIG. 8 is a block diagram illustrating a conference apparatus that may be used with one embodiment of the invention. For example, system 800 may represent any of the conference devices or conference server described above performing any of the processes or methods described above. System 800 can include many different components, where optional components are illustrated with dotted boxes. These components can be implemented as integrated circuits (ICs), portions thereof, discrete electronic devices, or other modules adapted to a circuit board such as a motherboard or add-in card of a computing system, or as components otherwise incorporated within a chassis of the computing system. Note also that system 800 is intended to show a high level view of many components of the computing system. However, it is to be understood that additional components may be present in certain implementations and furthermore, different arrangement of the components shown may occur in other implementations.

In one embodiment, system 800 includes processor 801, memory 803, and device units 805-808 that are interconnected via a bus or an interconnect 810. A conference device often contains all these components, while a conference server that is responsible for coordinating multiparty video conference sessions often do not contain components 804-808.

Processor 801 may represent a single processor or multiple processors with a single processor core or multiple processor cores included therein. Processor 801 may represent one or more general-purpose processors such as a microprocessor, a central processing unit (CPU), or processing device. More particularly, processor 801 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 801 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 801, which may be a low power multi-core processor socket such as an ultra low voltage processor, may act as a main processing unit and central hub for communication with the various components of the system. Such a processor can be implemented as a system on chip (SoC). Processor 801 is configured to execute instructions for performing the operations and steps discussed herein. System 800 further includes a graphics interface that communicates with graphics subsystem 804, which may include a display controller and/or a display device such as a monitor (e.g., a television).

Processor 801 may communicate with memory 803, which in an embodiment can be implemented via multiple memory devices to provide for a given amount of system memory. As examples, the memory can be in accordance with a Joint Electron Devices Engineering Council (JEDEC) low power double data rate (LPDDR)-based design such as the current LPDDR2 standard according to JEDEC JESD 209-2E (published April 2009), or a next generation LPDDR standard to be referred to as LPDDR3 that will offer extensions to LPDDR2 to increase bandwidth. As examples, 2/4/8 gigabytes (GB) of system memory may be present and can be coupled to processor 801 via one or more memory interconnects. In various implementations the individual memory devices can be of different package types such as single die package (SDP), dual die package (DDP) or quad die package (QDP). These devices can in some embodiments be directly soldered onto a motherboard to provide a lower profile solution, while in other embodiments the devices can be configured as one or more memory modules that in turn can couple to the motherboard by a given connector.

Memory 803 may include one or more volatile storage (or memory) devices such as random access memory (RAM), dynamic RAM (DRAM), synchronous DRAM (SDRAM), static RAM (SRAM), or other types of storage devices. Memory 803 may store information including sequences of instructions that are executed by processor 801, or any other device units. For example, executable code and/or data of a variety of operating systems, device drivers, firmware (e.g., input output basic system or BIOS), and/or applications can be loaded in memory 803 and executed by processor 801. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 800 may further include IO devices such as device units 805-808, including wireless transceiver(s) 805, video IO device unit(s) 806, audio IO device unit(s) 807, and other IO device units 808. Wireless transceiver 805 may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. System 800 may also include an ultrasound device unit (not shown) for transmitting a conference session code.

Video IO device unit 806 may include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips and conferencing. Audio IO device unit 807 may include a speaker and/or a microphone to facilitate voice-enabled functions, such as voice recognition, voice replication, digital recording, and/or telephony functions. Other optional devices 908 may include a storage device (e.g., a hard drive, a flash memory device), universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. Optional device units 808 may further include certain sensors coupled to interconnect 810 via a sensor hub (not shown), while other devices such as a keyboard or thermal sensor may be controlled by an embedded controller (not shown), dependent upon the specific configuration or design of system 800.

To provide for persistent storage of information such as data, applications, one or more operating systems and so forth, a mass storage (not shown) may also couple to processor 801. In various embodiments, to enable a thinner and lighter system design as well as to improve system responsiveness, this mass storage may be implemented via a solid state device (SSD). However in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 801, e.g., via a serial peripheral interface (SPI). This flash device may provide for non-volatile storage of system software, including a basic input/output software (BIOS) as well as other firmware of the system.

System 800 may be coupled to a network cloud such as network cloud 170, and the network may be coupled to electronic devices such as conference server 212 (e.g., when system 800 is a conference device) or conference devices 102-106 (e.g., when system 800 is a conference server), all discussed herein (e.g., in discussion relating to FIGS. 2 and 4). System 800 may perform methods discussed herein above relating to FIGS. 6 and 7.

In one embodiment, processor 801 of system 800 is configured to execute data and instructions stored in memory 803. The data and instructions include network interface 822, conference solution generator 824, and timer 828. Network interface 822 is configured to receive resource constraints from a number of conference devices of a multiparty video conference session. Each resource constraint is for a conference device. At least one resource constraint contains an indication of video capturing capability of a conference device.

Conference solution generator 824 is configured to compute a conference solution matrix based on the received resource constraints from the set of conference devices. When system 800 is a conference server, the conference solution matrix contains a number of solution entries, each corresponds to a conference device as discussed herein above. When system 800 is a conference device, the conference solution matrix contain a single entry and it is a solution entry for system 800 itself.

Network interface 822 is then configured to send the conference solution matrix to at least one conference device, where the conference device configures its settings for conferencing based on the conference solution matrix. When system 800 is a conference server, multiple solution entries are sent to conference devices, each to a conference device it corresponds to. When system 800 is a conference device, the single solution entry is sent to itself, which configures its components 804-808 for conferencing.

System 800 may update its conference solution matrix through timer 828. When timer 828 is expired and at least one updated resource constraint is received, conference solution 824 computes an updated conference solution matrix based on the updated resource constraint. The updated conference solution matrix is then sent out through network interface 822.

Note that while system 800 is illustrated with various components of a conference device, it is not intended to represent any particular architecture or manner of interconnecting the components; as such details are not germane to embodiments of the present invention. It will also be appreciated that a conference device having fewer components or perhaps more components may also be used with embodiments of the invention.

Some portions of the preceding detailed descriptions have been presented in terms of algorithms and symbolic representations of operations on data bits within a computer memory. These algorithmic descriptions and representations are the ways used by those skilled in conferencing technology to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a conference device, or similar electronic computing device, that manipulates and transforms data represented as physical (electronic) quantities within the conference device's registers and memories into other data similarly represented as physical quantities within the conference device's memories or registers or other such information storage, transmission or display devices.

Note the operations of the flow diagrams in FIGS. 6 and 7 are described with reference to the exemplary embodiment of FIG. 8. However, it should be understood that the operations of flow diagrams can be performed by embodiments of the invention other than those discussed with reference to FIG. 8, and the embodiments discussed with reference to FIG. 8 can perform operations different than those discussed with reference to the flow diagrams of FIGS. 6 and 7.

While the flow diagrams in the figures herein above show a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A method implemented at a conference apparatus, the method comprising:
receiving a plurality of resource constraints where each resource constraint is from a conference device in a plurality of conference devices, wherein at least a first resource constraint of a first conference device contains an indication of a video processing capability of the first conference device;
computing a conference solution matrix for the plurality of conference devices based on the plurality of resource constraints, wherein the conference solution matrix contains a solution entry for each of the plurality of conference devices, and wherein for the first conference device, a corresponding first solution entry indicates a video processing solution selection for the first conference device; and
sending solution entries to corresponding conference devices of the plurality of conference devices, wherein the corresponding conference devices configure their settings for a conferencing between the plurality of conference devices based on the solution entries.

2. The method of claim 1, wherein the first resource constraint identifies at least one
available computing power for conferencing of the first conference device,
available link bandwidth for the first conference device, and video decoding capability of the first conference device.

3. The method of claim 1, wherein the video processing solution selection for the first conference device includes at least one of:
a video capture resolution for each of one or more streams sending from the first conference device; and
a video capture rate of each of the one or more streams sending from the first conference device.

4. The method of claim 1, wherein the video processing solution selection for the first conference device includes a video decoding rate of each of one or more streams sending to the first conference device.

5. The method of claim 4, wherein the video decoding rate indicates a number of scalable layers of the video stream, and a number of frame rate at each scalable layer.

6. The method of claim 1, further comprising:
receiving at least one updated resource constraint from one of the plurality of conference devices;
computing, after a refresh interval, an updated conference solution matrix for the plurality of conference devices based on respective last received resource constraint of each of the plurality of conference devices; and
sending the solution entries to corresponding conference devices of the plurality of conference devices.

7. The method of claim 6, wherein the conference devices update their settings for conferencing based on the solution entries of the updated conference solution matrix, and wherein the updating causes a video stream display smooth at the first conference device.

8. The method of claim 1, wherein the conference apparatus is a conference server.

9. An apparatus comprising:
a memory configured to store data and instructions; and
a processors configured to execute a network interface and a conference solution generator stored in the memory,
the network interface configured to receive a plurality of resource constraints from a plurality of conference devices, the plurality of resource constraints including a resource constraint for each conference device in the plurality of conference devices, wherein at least a first resource constraint of a first conference device identifies video capturing capability of the first conference device,
and the network interface further configured to send solution entries of a conference solution matrix to corresponding conference devices of the plurality of conference devices, wherein the corresponding conference devices configure their settings for conferencing based on the solution entries, and
the conference solution generator configured to compute the conference solution matrix for the plurality of conference devices based on the plurality of resource constraints, wherein the conference solution matrix contains a solution entry for each of the plurality of conference devices, and wherein for the first conference device, a corresponding first solution entry indicates a video processing solution selection for the first conference device.

10. The apparatus of claim 9, wherein the first resource constraint received by the network interface further identifies at least one of:
available processor capability of the first conference device,
available link bandwidth for the first conference device, and video decoding capability of the first conference device.

11. The apparatus of claim 9, wherein the video processing solution selection for the first conference device computed by the conference solution generator includes a video capture resolution for one or more streams sending from the first conference device.

12. The apparatus of claim 9, wherein the video processing solution selection for the first conference device computed by the conference solution generator includes a video decoding rate for a video stream sending to the first conference device.

13. The apparatus of claim 12, wherein the video decoding rate indicates a number of scalable layers of the video stream, and a number of frame rate at each scalable layer.

14. The apparatus of claim 9, wherein the processor is further configured to execute a timer configured to set a refresh interval,
wherein the network interface is further configured to receive at least one updated resource constraint from one of the plurality of conference devices, and to send solution entries of an updated conference solution matrix to corresponding conference devices of the plurality of conference devices, and
wherein the conference solution generator is further configured to compute, after the refresh interval expires, the updated conference solution matrix for the plurality of conference devices based on respective last received resource constraint of each of the plurality of conference devices.

15. The apparatus of claim 14, wherein the conference devices update their settings for conferencing based on the solution entries of the updated conference solution matrix, and wherein the updating causes a video stream display smooth at the first conference device.

16. The apparatus of claim 9, wherein the apparatus is a conference server.

17. A non-transitory machine-readable medium having instructions stored therein, which when executed by a processor, cause the processor to perform operations at a conference apparatus, the operations comprising:
receiving a plurality of resource constraints from a plurality of conference devices, the plurality of resource constraints including a resource constraint for each conference device in the plurality of conference devices, wherein at least a first resource constraint of a first conference device contains an indication of video capturing capability of the first conference device;
computing a conference solution matrix for the plurality of conference devices based on the plurality of resource constraints, wherein the conference solution matrix contains a solution entry for each of the plurality of conference devices, and wherein for the first conference device, a corresponding first solution entry indicates a video processing solution selection for the first conference device; and
sending solution entries to corresponding conference devices of the plurality of conference devices, wherein the corresponding conference devices configure their settings for conferencing based on the solution entries.

18. The non-transitory machine-readable medium of claim 17, wherein the first resource constraint further includes at least one indication of:
available computing power for conferencing of the first conference device,
available link bandwidth for the first conference device, and video decoding capability of the first conference device.

19. The non-transitory machine-readable medium of claim 17, wherein the video processing solution selection for the first conference device includes at least one of:
a video capture resolution for one or more streams sending from the first conference device; and
a video capture rate of the one or more streams sending from the first conference device.

20. The non-transitory machine-readable medium of claim 17, wherein the operations further comprises:
receiving at least one updated resource constraint from one of the plurality of conference devices;
computing, after a refresh interval, an updated conference solution matrix for the plurality of conference devices based on respective last received resource constraint of each of the plurality of conference devices; and
sending the solution entries to corresponding conference devices of the plurality of conference devices.
